(19) United States
(12) Patent Application Publication
(10) Pub. No.: US 2013/0204725 A1
(43) Pub. Date: Aug. 8, 2013

(54) SYSTEM AND METHOD FOR PRICING, LEASING, AND TRANSFERRING OWNERSHIP OF TIRES

(71) Applicant: Scott Damon, Brentwood, TN (US)

(72) Inventor: Scott Damon, Brentwood, TN (US)

(21) Appl. No.: 13/759,080

(22) Filed: Feb. 5, 2013

Related U.S. Application Data
(60) Provisional application No. 61/595,969, filed on Feb. 7, 2012.
(60) Provisional application No. 61/595,980, filed on Feb. 7, 2012.
(60) Provisional application No. 61/595,985, filed on Feb. 7, 2012.
(60) Provisional application No. 61/595,987, filed on Feb. 7, 2012.
(60) Provisional application No. 61/595,990, filed on Feb. 7, 2012.
(60) Provisional application No. 61/595,997, filed on Feb. 7, 2012.

(51) Int. Cl. G06Q 30/06

(52) U.S. Cl. CPC G06Q 30/0621
USPC 705/20; 705/26.5

(57) ABSTRACT

Alternative techniques of pricing, leasing or transferring ownership of a new tire can provide a customer with increased options in procuring a new tire and can facilitate assembling customized new tires from select components. In embodiments, the new tire can be assembled from a new tire casing and a new tire tread. The sale or lease price of the new tire can be based in part on one or more factors including the price of the selected casing and price of the selected tread; lease of the casing or the tread; acceptance of second casing or tread; selection of guarantee options regarding fuel savings, extended life, or the like; and the cost-per-mile during use of the new tire. In embodiments, the techniques can be carried out with the assistance of a computer system configured to operate a tire customization and price calculating program.

### CROSS-REFERENCE TO RELATED APPLICATIONS

This patent application claims the benefit of priority to:
(1) U.S. Provisional Patent Application No. 61/595,969, filed on Feb. 7, 2012, and entitled “System and Method for Decentralized Manufacture of New Tires Enabling Improved Performance Characteristics”;
(2) U.S. Provisional Patent Application No. 61/595,980, filed on Feb. 7, 2012, and entitled “System and Method for Customizing Vehicle Tires on Demand at Point-of-Sale”;
(3) U.S. Provisional Patent Application No. 61/595,985, filed on Feb. 7, 2012, and entitled “System and Method for Reducing Point-of-Sale Tire Inventory”;
(4) U.S. Provisional Patent Application No. 61/595,987, filed on Feb. 7, 2012, and entitled “System and Method for Tracking Inventory of Tire Components at Point-of-Sale Facility”;
(5) U.S. Provisional Patent Application No. 61/595,990, filed on Feb. 7, 2012, and entitled “System and Method for Pricing, Leasing and Transferring Ownership of Tires”; and
(6) U.S. Provisional Patent Application No. 61/595,997, filed on Feb. 7, 2012, and entitled “System and Method for Customizing and Manufacturing Tires Near Point-of-Sale,”
   which are incorporated in their entireties herein by this reference.

### BACKGROUND OF THE INVENTION

The modern tire includes many sub-components and specialized materials. The components and materials can be selected and arranged so that the tire exhibits certain characteristics which are beneficial for its intended use. These considerations include weather conditions, wear-resistance, rolling resistance (resistance the tire must overcome to roll along the surface), durability, etc. Many organizations engaged in commerce and transportation operate large fleets of vehicles. The need for different tire designs and characteristics for these different fleets is as varied as their businesses.

Typically, new vehicles are provided with new tires which may not have the characteristics sought for the intended use of the vehicle. The operator of the vehicle may choose to replace these tires with other tires more suited to the intended use of the vehicle. The operator of the vehicle typically uses the tires mounted to the vehicle for a given number of miles or until it is determined that the tread is worn past a predetermined thickness. The operator can choose to replace the worn tire with a new replacement tire or, in some instances, to retread the worn tire.

New replacement tires are available through tire dealerships, maintenance shops and other point-of-sale facilities. As another option for replacing worn tires, retreading a worn tire is often used by professional truckers. In a retreading operation, as will be familiar to those of skill in the art, the worn tread is removed from the outer circumference of the existing tire and replaced with a new tread. Retreading may not be possible if the body of the tire becomes damaged or exceeds its useful life. Retreading is also generally not an option for replacing tires on passenger automobiles.

Typically, tire owners decide whether they wish to retread the tire using the original manufacturing company or another provider. As the tires are retreaded, the original manufacturer may lose control over the composition and performance characteristics of the tire. It would be beneficial if there were a system and method to avoid such undesirable consequences.

Accordingly, there is a need for increasing options and choices available to consumers of new tires while providing a consistent tire with desired performance characteristics. As a related matter, there is a need for ways to structure tire transactions to facilitate procuring new tires. The present disclosure is directed to addressing these and other needs in the tire industry.

### SUMMARY OF THE DISCLOSURE

In one embodiment, a tire transfer system is provided. A physical computer-readable medium includes a tire customization and price calculating program. A processor is adapted to execute the tire customization and price calculating program contained on the physical computer-readable medium. A data storage device is operably arranged with the processor. The data storage device is adapted to store tire component pricing data and new tire transfer data.

The tire customization and price calculating program is adapted to determine a particular type of casing and a particular type of tire tread for use in a tread-casing combination to form a new tire using tire selection information from a customer at a point-of-sale facility. The casing is separate from the tire tread. The tire customization and price calculating program is adapted to determine based upon the tread-casing combination at least one of (i) tire pricing using the tire component pricing data and (ii) tire transfer options using the new tire transfer data.

In another embodiment, a method of transferring possession of a new tire at a point-of-sale facility is described. A plurality of types of tire casings and a plurality of types of separate tire treads are provided at a point-of-sale facility. At least one of the types of tire casings is combinable with at least one of the types of separate tire treads into a new tire. A casing price is assigned to each type of tire casing, and the assigned casing prices are stored in a database. A tread price is assigned to each type of tire tread, and the assigned tread prices are stored in the database.

A processor is used to execute a tire customization and price calculating program contained on a physical computer-readable medium. In response to receiving tire selection information from a customer, the tire customization and price calculating program is adapted to determine a particular type of tire casing and a particular type of tire tread for use in a tread-casing combination to form a new tire using the tire selection information, and calculate a tire price for the new tire based in part upon the casing price of the particular type of tire casing and the tread price for the particular type of tire tread in the tread-casing combination.

In still another embodiment, a method of transferring possession of a new tire at a point-of-sale facility is described. A plurality of types of tire casings and a plurality of types of separate tire treads are provided at a point-of-sale facility. At least one of the types of tire casings is combinable with at least one of the types of separate tire treads into a new tire.

In response to receiving tire selection information from a customer, a particular type of tire casing and a particular type of tire tread for use in a tread-casing combination to form a new tire are determined using the tire selection information. A transfer arrangement is determined in which at least one of the tire tread and the tire casing is transferred to the customer by a lease or loan. In response to receiving an acceptance of the transfer arrangement by the customer, the new tire is built from the tread-casing combination.

Further and alternative aspects and features of the disclosed principles will be appreciated from the following detailed descriptions and the accompanying drawings. As will be appreciated, the principles relate to systems and methods for pricing, leasing, and transferring ownership of a tire disclosed herein are capable of being carried out in other and different embodiments, and are capable of being modified in various respects. Accordingly, it is to be understood that the foregoing general description and the following detailed description is exemplary and explanatory only and does not restrict the scope of the disclosed principles.

### BRIEF DESCRIPTION OF THE SEVERAL VIEWS OF THE DRAWINGS

FIG. 1 is a fragmentary perspective view, in section, of an embodiment of a pneumatic tire constructed according to principles of the present disclosure including a new tire casing and a separate new tire tread for assembly to the casing.

FIG. 2 is a transverse cross-sectional view of the tire of FIG. 1.

FIG. 3 is a schematic diagram of an embodiment of a system for tire production including manufacturers and point-of-sale facilities constructed according to principles of the present disclosure.

FIG. 4 is a screen display of an embodiment of a graphical user interface screen of a tire customization and price calculating program through which a customer can select components at a point-of-sale facility to be assembled into a new tire.

FIG. 5 is a flowchart that illustrates steps of an embodiment of a method for pricing and leasing or selling a new tire following principles of the present disclosure.

### DETAILED DESCRIPTION OF PREFERRED EMBODIMENTS

In some embodiments, different pricing, leasing and related sales techniques for transferring a tire to a customer are used with a method of producing tires at a point-of-sale facility by joining new tire casings and separate new tire treads at the point-of-sale facility. The pricing and transferring techniques cooperate with and leverage the production method to provide customers with increased variety and customization choices. The transfer and tire production techniques of the present disclosure can provide a customer with greater options in procuring a new tire that is custom manufactured from a new tire casing and a new tire tread.

In contrast to prior art methods where a new tire is sold as a single unit, the tire production method in some embodiments of the present disclosure enables different methods and models by which payment for transferring control of a tire made from the combined components can be received. For example, as described above, the tread typically wears out before the casing so that the same casing may be used with multiple new treads. In one embodiment, a new tire casing and a new separate tire tread are priced and sold separately, and are then joined together to provide the customer with a complete new tire.

In another embodiment, the new casing is leased to the customer, and the separate new tread for assembly to the leased casing is sold to the customer. After the useful life of the tread is expended, the customer has the option of returning the casing or renewing the lease of the casing and purchasing another separate new tread to be installed on the leased casing. This transfer technique may be advantageous because treads typically become worn before casings.

In still another embodiment, the pricing structure (either by lease or sale) of the new tire and/or new tire casing and new tire tread can be based upon whether the customer agrees to take possession of a second separate new tread, either by sale or gift, in the future. For example, a new tire made from a casing and tread combination can be offered at one price, and the same new tire can be offered at a lower price if the customer agrees to purchase at least one future replacement tread from the same manufacturer or point-of-sale facility. In a related arrangement, a free new tread can be offered to the customer if the customer agrees to return, after the useful life of the present tread combined with the casing, to the point-of-sale location for retreading services. This transfer technique can help garner repeat business at the point-of-sale facility. In yet other embodiments, the lease and/or sale price of the new tire can also be adjusted based upon the selection of guarantee options that are made available to the customer.

In one arrangement, a method for transferring a new tire includes providing at a point-of-sale facility a new tire casing and a separate new tire tread for combination into a new tire assembly. A lease and/or sale price of the new tire is conditioned at least in part on transferring possession of a second new tire tread. A completed new tire assembly is delivered to a customer.

In some embodiments, the transfer techniques of the present disclosure are facilitated by the use at the point-of-sale facility of a system including a physical computer-readable medium including a tire customization and price calculating program and a processor adapted to execute the tire customization and price calculating program contained on the physical computer-readable medium. The computer system can be used to operate the tire customization and price calculating program to launch a graphical user interface adapted to display a preference tree in which various customization choices between casings and treads are provided to the customer. The graphical user interface can also be adapted to provide pricing and/or leasing options to the customer based upon the casing and the separate tread selected by the customer. The processor can store the selections made for record keeping purposes in a suitable database.

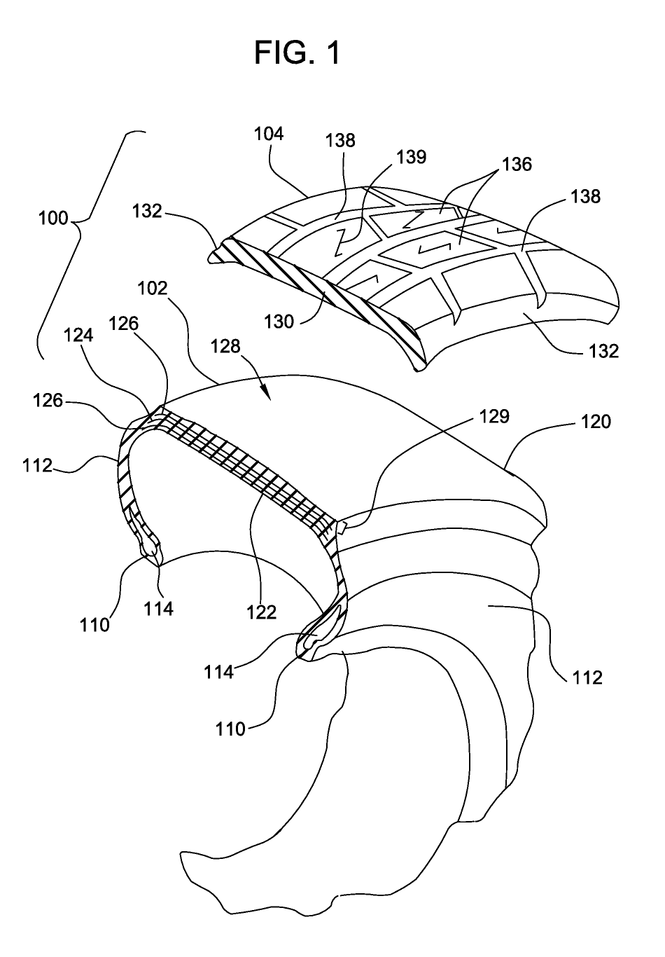

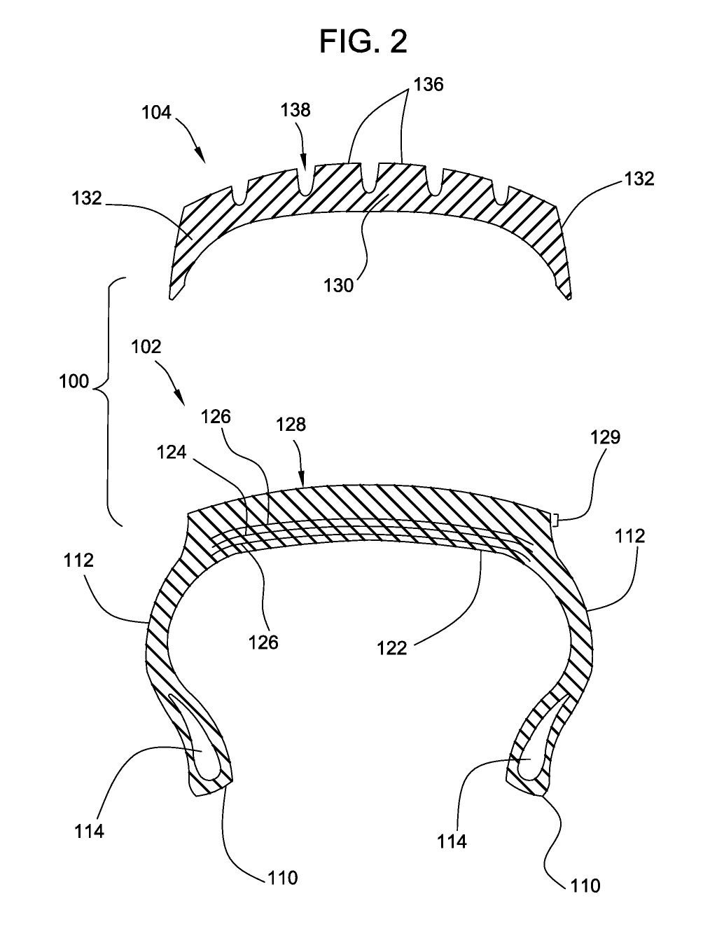

Turning now to the drawings, wherein like reference numbers refer to like elements, there is illustrated in FIGS. 1 and 2 an embodiment of a new pneumatic tire 100 in accordance with principles of the present disclosure. Pneumatic tires of the type shown may be used on trucks, buses, construction vehicles, passenger vehicles or any other type of vehicle that travels over a paved road or other surface. Although the tire 100 is illustrated in cut-away to better depict the components, it will be appreciated that the complete tire is an annular torus. The pneumatic tire 100 includes a new tire casing 102 and a separate new tire tread 104 having a tread pattern thereon. The casing 102 provides support and the structural form of the tire that carries the weight of the vehicle when traveling on a road or highway. The casing 102 has a generally U-shaped cross-section that, when attached to a rim, can be inflated with and trap air or other gas, generally at several times that of atmospheric pressure.

The casing 102 is typically made of various plies and layers of different materials and includes various sub-parts that perform different functions. For example, the casing includes distal, enlarged beads 110 disposed along depending sidewalls 112 of the U-shaped cross-section. The beads 110 sealingly engage corresponding structures on the rim to secure the tire to the rim. To enlarge the bead 110, a bead filler 114 or a bead cord made of dense rubber, steel or fabric, is enclosed within the bead. The sidewalls 112 extend radially outwardly from each of the beads 110 and may be made of molded rubber. To join the two opposing sidewalls 110 and complete the U-shaped cross section, the casing includes a cap 120. The sidewalls 112 and the cap 120 can be integrally molded together and each may include several layers. For example, to prevent the pressurized air from escaping the inflated tire, an inner liner 122 made from gas impermeable rubber or elastomer can be disposed along the inner surface of the U-shaped cross section of the casing 102.

To provide support and puncture resistance, various plies can be circumferentially layered on top of the inner liner 122. These plies may include a steel belt 124 made from closely-spaced, slightly flexible steel cords or wires encased in rubber. A nylon or rubber body ply 126 may be layered over or under the steel belt 124 to sandwich the steel belt. Cushion gum may be included to isolate the steel belt and prevent it from wearing against other components. Other plies may include a body ply made of reinforced woven fabric such as nylon or rayon that is suspended in rubber. The components are assembled together and encased integrally with each other in rubber. The outermost circumferential surface 128 of the casing 102 is relatively smooth and may lack a pattern or texture.

To provide sufficient traction to propel the vehicle when the tire rotates, the tread 104 is disposed circumferentially along the outer circumferential surface 128. The tread 104 can be an extruded or molded profile of rubber and can include tread shoulders 132 on either side which are joined together by an arching tread backing 130. When assembled to the casing 102, the tread shoulders integrally align with and join to the sidewalls 112, and the tread backing 130 extends circumferentially along the smooth surface 128. The tread 104, therefore, forms the circumferential exterior of the finished tire 100.

The tread 104 can have a pattern of lugs, grooves, ribs, and/or ridges. The pattern can form several lugs 136 separated by gaps or grooves 138. Thin sipes 139 may be defined by the lugs. The grooves 138 can help accommodate and redirect water when the tire 100 is on slick or wetted surfaces to prevent the vehicle from hydroplaning. Many types of tire treads exist for various purposes. For example, tread patterns may be designed for certain weather and precipitation conditions, improved gas mileage, off-road use, reduced noise generation, improved wear resistance, etc.

In contrast to the situation where a complete tire including a tire casing and tread is made as a unitary finished product and distributed to various point-of-sales facilities, in embodiments of the present disclosure, a new tire casing and a new separate tire tread are manufactured as separate components and supplied as separate components to a point-of-sale facility. The separate casing and tread components can be made either at a single location or at different locations in other embodiments. At the point-of-sale facility, the casing and the separate tread can be assembled to form a new tire and installed on a customer's vehicle. Advantageously, customers at the point-of-sale facility can be afforded greater selection and the ability to obtain a customized new tire from a large variety of possible combinations of casings and separate tread patterns available using this approach. A related advantage is that the method reduces inventory that must be held in stock at the point-of-sale facility in comparison to a conventional supply technique using tires made as a unitary finished product.

The casing 102 and the tread 104 can be made and cured separately at the respective manufacturing facilities to harden and set the rubber and components. In embodiments in which the casing and the tread are cured separately at the time of manufacture, the curing temperature profile used for the separate components can be selected to suit the specific materials and dimensions of the respective component part. Selective curing of separate parts can help avoid over-cured or under-cured regions within the parts due to excessive or inadequate heat. In addition, the casing and separate tread can include distinct additives which are selected to help enhance the performance characteristics of the particular component.

To make a tire at the point-of-sale facility, the consumer can select a new casing and separate new tread for assembly into a completed tire. To fit the components together and to remove any oxidized rubber from the casing that may have formed while it was in storage, a layer of rubber can be removed from the outermost circumferential surface 128 of the cap 120 by a buffing process. In some embodiments, the casing may be intentionally provided with excess material, as indicated by arrow 129 in FIG. 1, for this purpose.

In embodiments in which excess material 129 may be removed from the casing 102 by buffing the outermost circumferential surface 128 before assembly to the tread 104, the buffing process can allow for adjusting the final dimensions including the outside diameter of the finished tire. For example, removing more or less excess material will correspondingly increase or decrease the outer diameter. As a related advantage, the buffing process can also adjust or accommodate the tread depth and other dimensional factors that effect the tire's overall performance.

The tread 104 is wrapped around the remaining outermost circumferential surface 128 of the casing and the two components are vulcanized in an autoclave or similar device at the point-of-sale facility. Heating the components in the autoclave causes cross-linking between the rubber materials forming an integral bond between the casing and tread. Cushion rubber can be inserted between the casing 102 and the tread 104 before the parts are assembled and joined together to enhance the bond therebetween. In other embodiments, other suitable methods can be employed for assembling the casing 102 and the tread 104.

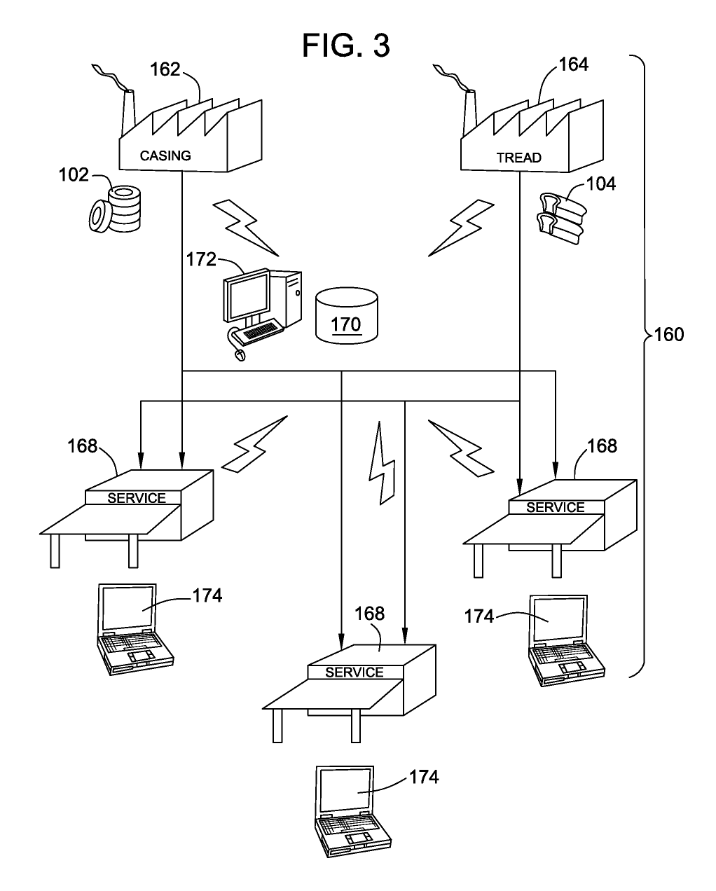

A production method including a new tire casing and a separate new tire tread assembled at a point-of-sale facility can facilitate a tire manufacturing, distribution and sales network that provides end customers with increased tire variety and customization. For example, referring to FIG. 3, there is illustrated a network 160 for manufacturing and distributing tire components to be assembled into complete new tires. To manufacture the components, the network 160 includes a casing manufacturing facility 162 that produces new tire casings 102 and a tread manufacturing facility 164 that produces new tire treads 104. In the illustrated embodiment, the casing manufacturing facility 162 and the tread manufacturing facility 164 are at different locations but, as indicated above, can be the same facility in other embodiments. To interface with customers, the network 160 includes a plurality of point-of-sale facilities 168 where the new tires can be assembled and installed on vehicles. The point-of-sale facilities 168 can be any suitable facility, such as, tire dealers, tire replacement shops, vehicle maintenance and repair facilities, and new vehicle dealers, for example. The point-of-sales facilities 168 can be affiliated with the manufacturing facilities, e.g., as part of the same company or corporation, franchisees of the manufacturing facilities or, in other embodiments, completely distinct and unrelated companies. After manufacture at the casing manufacturing facility 162 and the tread manufacturing facility 164, the casings 102 and treads 104 are delivered to the point-of-sales facilities 168 without being joined together.

To coordinate between the manufacturers 162, 164 and point-of-sales facilities 168, the network can utilize communication channels, including telephony and computer-assisted communication technology. For example, the network can include a central database 170 or another type of computer readable storage memory and an associated computer 172 for storing and processing information regarding inventory supplies at the point-of-sale facilities, lead-time for components, demand forecasting, sales and pricing data, etc. The database 170 and associated computer 172 can communicate with the point-of-sale facilities 168 via any suitable communications network such as, for example, a web platform over the internet. The point-of-sales facilities 168 can include equipment such as computers 174 for this purpose. The central database 170 and computer 172 can also be in communication with the casing manufacturing facility 162 and the tread manufacturing facility 164. Although the example in FIG. 3 shows communications and processing directed from a central location, it will be appreciated that in other embodiments this functionality can be distributed among several locations, including the point-of-sale facilities 168 themselves, using suitable equipment.

Because each point-of-sale facility has the ability to assemble new tires from the separate casings and treads on hand, the point-of-sale facilities can provide customized new tires per customer demand. For example, each point-of-sale facility can carry several types of tire casings and several types of tire treads with different performance characteristics. Some casing types may exhibit heightened cornering abilities, for example, and others may be structurally reinforced for off-road hauling such as for use on dump trucks, for example. Different tread and casing combinations can provide varying degrees of rolling resistance (energy dissipated when the tire rolls over a surface); wear resistance, noise generation, as well as characteristics for addressing specific weather conditions such as snow or rain. Customers at the point-of-sale facility can select casings and treads based on their driving preferences and/or the intended application of the vehicle.

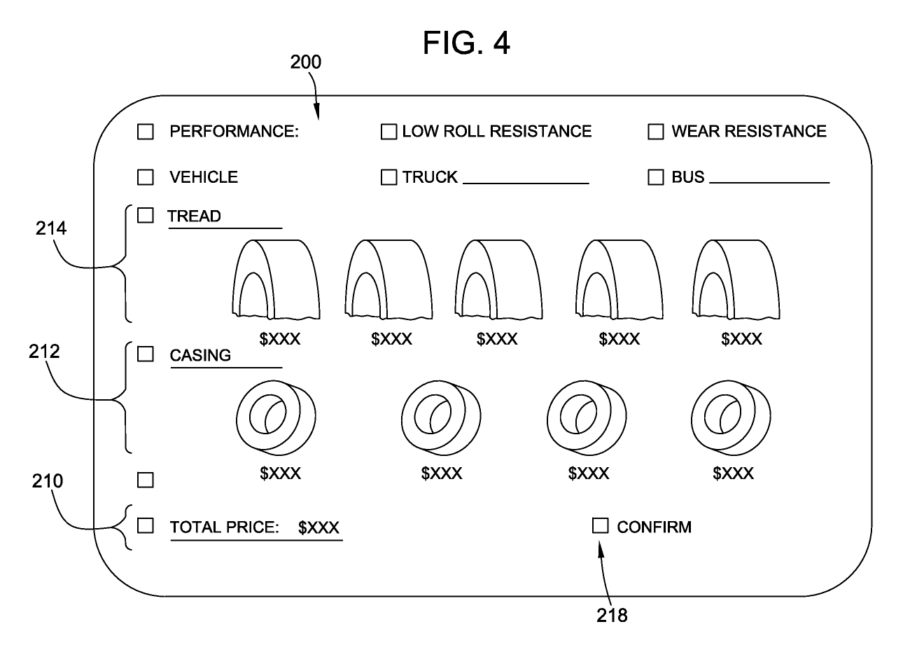

In some embodiments, the selection process can be assisted by the use of a computer system programmed with software stored on a physical computer readable medium having instructions for facilitating the selection process. Referring to FIG. 4, a tire customization and price calculation program can provide, on a visual display device at the point-of-sale facility, a graphical user interface 200 including at least one graphical screen that shows the casing types 212 and the tread types 214 available for selection. The display device is adapted to display the graphical user interface 200 and to receive tire selection information from the customer. The processor can be arranged with the display device and is adapted to receive the tire selection information from the display device through the graphical user interface 200. In embodiments, the tire customization and price calculating program is adapted to display in the graphical user interface 200 a preference tree in which various customization choices between a plurality of tread-casing combinations is provided.

The tire customization and price calculating program is adapted to display in the graphical user interface 200 pricing and/or leasing options to the customer based upon the selected tread-casing combination. Other information can include performance characteristics, intended uses for the tire, sizes, materials etc., for the tire. The customer may have the ability to select via an appropriate input-output device of the display device desired characteristics and/or a specified intended use. Further, the tire customization and price calculation program can include instructions for checking availability from stock, providing recommendations to the customer or prioritizing among competing preferences, etc. The tire customization and price calculation program can be operated within the network 160 of FIG. 3.

Alternative techniques for pricing, leasing or otherwise transferring ownership of a new tire can be used in accordance with principles of the present disclosure. The techniques can complement embodiments of the production model following principles of the present disclosure to provide customers with increased flexibility in procuring and paying for a new tire. In some embodiments, the techniques can be implemented via a network 160 such as the one illustrated with respect to FIG. 3 and may receive information and or instructions from customers at the point-of-sale facilities via an onsite display device hosting a graphical user interface.

For example, in one embodiment, the tire casing and tire tread can be offered for sale separate from each other at the point-of-sale facility. After both components have been selected by the customer, the point-of-sale facility can assemble them to provide the customer with a complete new tire. The customer can pay for each component separately.

Referring to FIG. 4, to facilitate this embodiment, the tire customization and price calculation program can display in the graphical user interface a plurality of tread types 214 having different tread patterns and/or performance characteristics and with each tread style having an associated price. The customization and price calculation program may also display a plurality of casing types 212 having different performance characteristics with each casing type having an associated price. Once the customer selects both a tread style 214 and a casing type 212, the customization and price calculation program can display a total price 216 that may be the sum of the two displayed prices associated with the selected tread style and casing type. In other arrangements, the total price can be calculated, based upon the selected casing and tire tread, as a sum that is different than the sum of the separate prices. By selecting a confirmation feature 218, the sale may be confirmed and the point-of-sale facility proceeds to assemble and, in some embodiments, install the new tire.

However, the customer may be only interested in purchasing a tread style 214, for instance, if replacing a worn tread on a tire already possessed by the customer. In such instances, the customer may select to purchase only the tread style 214, whose price would be reflected in the total price 216. Likewise, the preferred tread style may not be available, e.g., out of stock at the particular point-of-sale facility, at which time the customer may only purchase a casing type 212.

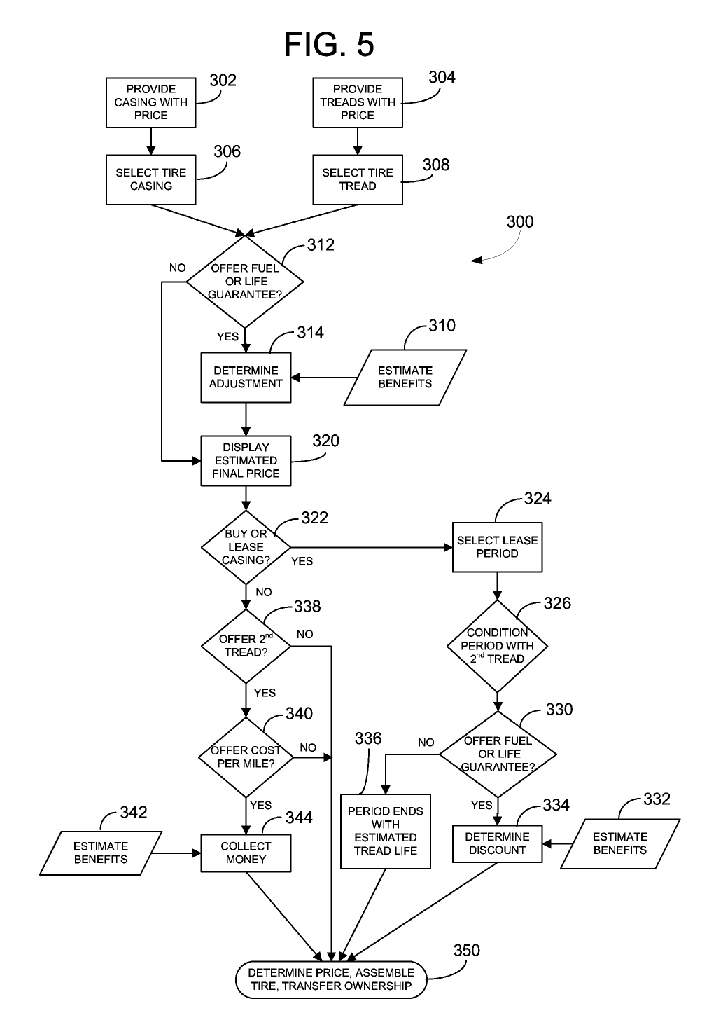

Referring to FIG. 5, there is illustrated a flowchart for carrying out a series of steps of an embodiment of a method for transferring a tire to a customer. The method 300 begins with the steps of providing a plurality of tire casings 302 and providing a plurality of tire treads 304 at a point-of-sale facility. Prices can be associated with each type of casing and each style of tread. The customer can select a casing at a selection step 306 from among the casing types available and select a tread at a selection step 308 from among the tread types available based, for example, on desired price limits and performance requirements.

The method 300 can offer price adjustments with respect to a tread selection in conjunction with a previously-selected casing 306. For example, the tire customization and price calculating program can calculate a total price for a tire that is different than the sum of the selected casing and tread if those components were purchased separately. In some embodiments, the pricing structure of certain casing and tread combinations can be lowered to encourage a customer to select those particular combinations.

Certain tread style and casing combinations may exhibit low rolling resistance and therefore correspond to increased mileage and fuel savings. Other tread style and casing combinations may exhibit increased wear resistance and life expectancy. This information can be determined empirically or theoretically in a benefit estimation step 310. Information regarding fuel savings, life expectancy and other benefits can be stored on and accessible from a computer readable memory.

Based on the information, the customer may be offered in a guarantee option determination step 312 possible price adjustments with respect to different casing types, tread types, and/or combinations thereof. In embodiments, the customer can be offered a performance guarantee relating to the new tire. The tire customization and price calculating program can adjust the tire price based upon the acceptance of the performance guarantee.

For example, the customer may be offered a relatively more expensive tread type, but with a guarantee of fuel savings and/or increased tire life. Thus, the estimated fuel savings or increased life may be accounted for in the price of the tread. In embodiments, the performance guarantee is conditioned at least in part on the type of tire tread used in the tread-casing combination.

If selected, the point-of-sale facility or a third party can provide a guarantee that the selected casing and tire tread combination will perform according to the guarantee. If the resulting new tire does not perform according to the guarantee, the guarantee can require the guarantor to provide some form of compensation to the customer, such as by providing a replacement tire free of charge or at a reduced price, or by returning some or all of the original price paid by the customer. If the customer selects the guarantee 312, the tire customization and price calculation program can then determine a price adjustment 314 for the tread types offered. The customer may also return to the selection steps 302 and 304 and reselect casings and treads to determine if other guarantee options may be presented for the newly selected combinations.

The estimated sales price of a new tire assembly based on the selected casing type and tread style can be displayed to the customer in display step 320. Rather than purchase the new tire assembly, the customer can be provided with a sale or lease option at step 322. The sale or lease option 322 can be related to both the casing and the tread or to either the casing or the tread. For example, the customer can be given a lease option 322 of leasing the casing with the opportunity of returning it after the useful life of the tread is expended.

In embodiments, the new tire can be offered at a combined tire price if the customer agrees to purchase at least one future replacement tire tread from the point-of-sale facility. The combined tire price can be less than a sum of the calculated tire price and the tread price of the type of tire tread offered as the future replacement tire tread. In yet other embodiments, at least one of the calculated price of the new tire and the tread price of a second, separate tire tread can be adjusted based upon whether the customer agrees to take possession of the second, separate tire tread, either by sale or gift, in the future. In still other embodiments, the customer can be offered a replacement tire tread at a discounted price or free if the customer agrees to return to the point-of-sale facility at a later time for retreading services for the new tire.

If the customer selects the lease option 322, the next step is to determine a lease period 324. The lease period can be in terms of time, miles driven or by another suitable measurement. In some embodiments, the lease period can be conditioned in part on the customer obtaining a second tread for future use on the same casing in a conditioning step 326. Specifically, the lease period can be extended if the customer agrees to purchase a second tread from the point-of-sale facility or lessor, either at the time of the expiration of the lease or in the future. Alternatively, a second tread for future use may be offered free of charge or at a reduced price as an incentive for the customer to agree to a longer lease period. Other conditions can include the purchase of additional assembled new tires, maintenance and service agreements or the like.

In the event the customer selects a second tread, the method can present a guarantee option 330 to the customer based on the style of the second tread offered, the combination of the previously selected casing with the tread types offered, or on the length of the lease period. For example, a guaranteed tire replacement may be used as an incentive for securing a longer lease period for the tire components. Likewise, as stated above, fuel savings may be guaranteed to encourage the purchase of more expensive tread types. The benefits underlying the guarantee offers can be predetermined in an estimation step 332 so that consistent, verified offers can be made by the point-of-sale facility or lessor. The information can be stored in computer readable memory and accessed by the tire customization and price calculation program. If the guarantee option 330 is selected, an adjustment step 334 determines the adjustment to the lease term and/or price. If the customer does not select a second tread and/or the guarantee option, the method can in a default step 336 adopt a predetermined lease period, for example, the estimated life of the tire.

Referring back to the lease option 322, if the customer does not select the leasing option for either the casing or the tread, the point-of-sale facility may still offer the option 338 of selecting a second tread, possibly for future use on the same casing or on a different casing if the customer is procuring more than one at the time. To encourage selection of the second tread option 338, additional benefits such as further price reduction with respect to either the casing, the second tread, or the assembled tire can be offered.

In some embodiments, the process can offer a cost-per-mile option 340 in which the price of the tire is based at least in part on the distance (such as the number of miles or kilometers, for example) the vehicle to which the tire is mounted is driven. For example, using the odometer of the vehicle, the vehicle mileage can be recorded at the time the tire is installed and again at some other predetermined event, such as replacement of the worn tread or the entire tire. Costs can be assessed based on the difference in the mileage. Radio frequency identification tags, onboard microprocessors and other electronic components can be used to record mileage in addition to the odometer. The cost-per-mile option can include an offer to include price reductions based upon the distance the vehicle travels with that particular tire mounted to it (e.g., for every 500 miles traveled, the customer gets an additional 100 miles of travel free of charge) to encourage particular purchasing decisions regarding casing types and tread types such as promoting wear resistance and prolonged life. The data and information for performing the cost-per-mile option can be determined in an estimation step 342 and stored in a computer accessible memory for current and later use. The cost-per-mile option 340 also contemplates a future collection step 344 for collection of money based on mileage.

In a further variation of the cost-per-mile option, an upfront price can be established at the time the tire is assembled based upon an anticipated distance for the tire's service life. A rebate can be issued at a later date if the tire is returned after having been driven for less than the originally-projected miles, or a surcharge can be added if the number of miles exceeds the original number.

Referring back to the leasing option 322, in another variation of the above method, the tire casing can be loaned to the customer rather than leased. The customer still may have the option of selecting a tread from among the various tread types for assembly to the casing. The customer may purchase the tread or may procure it by other means. Such an arrangement may be useful if tread wear is expected to be excessive and the customer may require several treads during use of the tire casing. This arrangement may be further modified as a requirements contract whereby the point-of-sale facility agrees to supply all treads required by the customer. At the conclusion of the method 300, the final price is determined and the tire is assembled and transferred to the customer in a final step 350. If implemented in a computer system, the final price can be calculated by the computer. Additionally, the transactions including with respect to the selection of any second treads or cost-per-mile agreements may be stored in computer accessible memory for recordation purposes and later access.

In one arrangement, a method for transferring a new tire includes providing at a point-of-sale facility 168 a new tire casing 102 and a separate new tire tread 104 for combination into a new tire assembly 100. A lease and/or sale price of the new tire is conditioned at least in part on transferring possession of a second new tire tread 104 is established. A completed new tire assembly 100 is delivered to a customer.

In some embodiments, a new tire casing 102 is leased to a customer and a new tire tread 104 is sold to the customer. The lease period for the new tire casing 102 can be conditioned on an estimated life of the new tire tread 104. The estimated life can be in terms at least one of time or miles.

In another embodiment, a computer-assisted method for transferring a new tire at a point-of-sale facility 168 can include providing at a point-of-sale facility a plurality of types 212 of new tire casings 102 and a plurality of types 214 of new tire treads 104. At least one of the types 212 of new tire casings 102 is combinable with at least one the types 214 of separate new tire treads 104 into a new tire 100. A casing price is assigned to each type 212 of new tire casing 102 and the casing price information is stored in a database 170. A tread price for each style 214 of new tire tread 104 is assigned, and the tread pricing information is stored in a database 170. A customer's selection, at the point-of-sale facility, of a new tire casing 102 from the plurality of types 212 of new tire casings is received by a tire customization and price calculation program. The customer's selection, at the point-of-sale facility 168, of a new tire tread 104 from the plurality of types 214 of new tire treads for combination with the selected new tire casing 102 into a new tire assembly 100 is received by the tire customization and price calculation program. The tire customization and price calculation program calculates a final price for the assembled new tire 100 based upon the casing price for the selected new tire casing 102 and the tread price for the selected new tire tread 104.

The customer can be offered a second new tire tread 104 for the selected new tire casing 102. The customer can be offered a guarantee of at least one of fuel savings and extended life 330 conditioned at least in part on the casing type 212 and tread style 214 selected. The final price can be adjusted based upon the acceptance of the guarantee.

In other embodiments, a computer-assisted method of pricing a new tire can include providing at a point-of-sale facility 168 a plurality of types 212 of new tire casings 102 and a plurality of types 214 of new tire treads 104. At least one of the types 212 of new tire casings 102 is combinable with at least one of the types 214 of separate new tire treads 104 into a new tire 100. A first price associated with each type 212 of new tire casing 102 can be stored in a database 170. A second price associated with each style 214 of new tire tread 104 can also be stored in the database 170. An estimated fuel savings rating can be associated with each combination of casing type 212 and/or tread style 214 can be stored in a database 170. A customer's selection, at the point-of-sale facility 168, of a new tire casing 102 from the plurality of types 212 of new tire casings is received by a tire customization and price calculation program. The customer's selection, at the point-of-sale facility 168, of a new tire tread 104 from the plurality of types 214 of new tire treads for combination with the selected tread casing into a new tire assembly 100 is received by the tire customization and price calculation program. The tire customization and price calculation program calculates a price for the new tire assembly 100 based at least in part on the casing price associated with the selected new tire casing 102, the tread price associated with the selected new tire tread 104, and the fuel savings rating for the selected combination. In some embodiments, the fuel savings rating can be associated exclusively with either the casing type of the new tire casing or with the tread style of the new tire tread.

In embodiments, the disclosure provides systems and methods for pricing, leasing and/or transferring ownership of a new tire assembly. According to the disclosure, a new tire casing is manufactured and delivered to a point-of-sale facility. A new tire tread is separately manufactured and delivered to the point-of-sale facility. The new tire casings can be provided in a plurality of different types and the new tire treads can be provided in a plurality of different types. A customer at the point-of-sale facility can select a casing from the different types of the new tire casings and a tread from the different types of new tire treads. The selected casing and the selected tread can be assembled together at the point-of-sale facility to produce a new tire assembly.

Because the new tire casing and the new tire tread are separate from each other at the point-of-sale facility, different techniques can be applied to transfer the new tire assembly or its components to a customer. For example, in an embodiment, one of the tire components such as the new tire casing and/or the new tire tread can be leased to the customer while the other component is sold to the customer. In another embodiment, the final price of the new tire assembly can be conditioned in part upon some future activity of the customer, such as a future commitment to purchase or accept a second new tire tread from the point-of-sale facility. In a further embodiment, the new tire assembly can be offered in conjunction with a guarantee such as fuel savings or extended life based on the selected tire components, for example. Additional alternative pricing, leasing and transferring strategies are contemplated by the disclosure.

In accordance with another aspect of the disclosure, computer software or computer implemented programs stored on tangible, computer-readable media can be provided to assist in carrying out the various disclosed methods. Such assistance may be provided by a computer network associated with a point-of-sale facility. The computer network may include a database or other memory that can store various information about the tire components such as, for example, pricing and performance characteristics. Additional information that may be communicated to the customer can relate to pricing discounts or price or service guarantees that may be associated with the new tire assembly or its components. This information can be determined by a tire customization and price calculation program that includes a graphical user interface displayed on an on-site visual display device.

In embodiments, the pricing, leasing and ownership transfer methods and strategies can provide the tire customer with an increased number of options for obtaining a new tire assembly. In embodiments, the disclosed pricing, leasing and transferring methods can facilitate repeat business opportunities by closely associating the customer with the point-of-sale facility.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tire transfer system comprising:
a physical computer-readable medium including a tire customization and price calculating program;
a processor adapted to execute the tire customization and price calculating program contained on the physical computer-readable medium;
a data storage device operably arranged with the processor, the data storage device adapted to store tire component pricing data and new tire transfer data;
wherein the tire customization and price calculating program is adapted to determine a particular type of casing and a particular type of tire tread for use in a casing-tread combination to form a new tire using tire selection information from a customer at a point-of-sale facility, the casing being separate from the tire tread, and the tire customization and price calculating program is adapted to determine based upon the casing-tread combination at least one of (i) tire pricing using the tire component pricing data and (ii) tire transfer options using the new tire transfer data.

2. The tire transfer system of claim 1, wherein the tire customization and price calculating program includes a graphical user interface, the system further comprising:
a display device adapted to display the graphical user interface and to receive the tire selection information from the customer;
wherein the processor is arranged with the display device and is adapted to receive the tire selection information from the display device.

3. The tire transfer system of claim 2, wherein the tire customization and price calculating program is adapted to display in the graphical user interface a preference tree in which various customization choices between a plurality of casing-tread combinations is provided.

4. The tire transfer system of claim 2, wherein the tire customization and price calculating program is adapted to display in the graphical user interface pricing and/or leasing options to the customer based upon the selected casing-tread combination.

5. A method of transferring possession of a new tire at a point-of-sale facility, the method comprising:
providing at a point-of-sale facility a plurality of types of tire casings and a plurality of types of separate tire treads, at least one of the types of tire casings being combinable with at least one of the types of separate tire treads into a new tire;
assigning a casing price to each type of tire casing and storing said assigned casing prices in a database;
assigning a tread price to each type of tire tread and storing said assigned tread prices in the database;
using a processor to execute a tire customization and price calculating program contained on a physical computer-readable medium;
in response to receiving tire selection information from a customer, the tire customization and price calculating program:
determining a particular type of tire casing and a particular type of tire tread for use in a casing-tread combination to form a new tire using the tire selection information, and
calculating a tire price for the new tire based in part upon the casing price of the particular type of tire casing and the tread price for the particular type of tire tread in the casing-tread combination.

6. The method for transferring possession of a new tire at a point-of-sale facility of claim 5, further comprising:
offering the customer a performance guarantee relating to the new tire; and
wherein the tire customization and price calculating program adjusts the tire price based upon the acceptance of the performance guarantee.

7. The method for transferring possession of a new tire at a point-of-sale facility of claim 6, wherein the performance guarantee comprises at least one of fuel savings and extended life.

8. The method for transferring possession of a new tire at a point-of-sale facility of claim 6, wherein the performance guarantee is conditioned at least in part on the type of tire tread used in the casing-tread combination.

9. The method for transferring possession of a new tire at a point-of-sale facility of claim 5, further comprising:
offering the new tire at the calculated tire price.

10. The method for transferring possession of a new tire at a point-of-sale facility of claim 5, further comprising:
offering the new tire at a combined tire price if the customer agrees to purchase at least one future replacement tire tread from the point-of-sale facility, the combined tire price being less than a sum of the calculated tire price and the tread price of the type of tire tread offered as the future replacement tire tread.

11. The method for transferring possession of a new tire at a point-of-sale facility of claim 5, further comprising:
adjusting at least one of the calculated price of the new tire and the tread price of a second, separate tire tread based upon whether the customer agrees to take possession of the second, separate tire tread, either by sale or gift, in the future.

12. The method for transferring possession of a new tire at a point-of-sale facility of claim 5, further comprising:
offering the customer a replacement tire tread at a discounted price or free if the customer agrees to return to the point-of-sale facility at a later time for retreading services for the new tire.

13. The computer-assisted method of claim 5, wherein the tire price for the new tire is different than a sum of the tire tread price and the casing price.

14. The computer-assisted method of claim 5, wherein the tire customization and price calculating program calculates the new tire price using a cost-per-distance option correlating the final price of the new tire assembly with a total travel distance of the new tire.

15. The method for transferring possession of a new tire at a point-of-sale facility of claim 5, further comprising:
assembling the casing-tread combination to form the new tire at the point-of-sale facility.

16. A method of transferring possession of a new tire at a point-of-sale facility, the method comprising:
providing at a point-of-sale facility a plurality of types of tire casings and a plurality of types of separate tire treads, at least one of the types of tire casings being combinable with at least one of the types of separate tire treads into a new tire;
in response to receiving tire selection information from a customer, determining a particular type of tire casing and a particular type of tire tread for use in a casing-tread combination to form a new tire using the tire selection information;
determining a transfer arrangement in which at least one of the tire tread and the tire casing is transferred to the customer by a lease or loan;
in response to receiving an acceptance of the transfer arrangement by the customer, building the new tire from the casing-tread combination.

17. The method of transferring possession of a new tire at a point-of-sale facility of claim 16, wherein the tire casing is leased to the customer and the tire tread is sold to the customer.

18. The method of transferring possession of a new tire at a point-of-sale facility of claim 17, wherein the lease of the tire casing has a lease period based upon on an estimated life of the tire tread.

19. The method of claims 18, wherein the estimated life is determined in terms of at least one of time and distance.

20. The method of claim 16, wherein the transfer arrangement of the new tire is conditioned at least in part on transferring possession of a second tire tread to the customer.
